(19) United States
(12) Patent Application Publication
(10) Pub. No.: US 2024/0200658 A1
(43) Pub. Date: Jun. 20, 2024

(54) SEALS AND METHODS OF MAKING AND USING THE SAME

(71) Applicant: SAINT-GOBAIN PERFORMANCE PLASTICS CORPORATION, Solon, OH (US)

(72) Inventor: Roberto CANNIOTO, Lecco (IT)

(21) Appl. No.: 18/545,740

(22) Filed: Dec. 19, 2023

Related U.S. Application Data
(60) Provisional application No. 63/476,004, filed on Dec. 19, 2022.

(51) Int. Cl. F16J 15/3232

(52) U.S. Cl. CPC F16J 15/3232

(57) ABSTRACT

A seal including: a metal annular body oriented down a central axis, the metal annular body comprising an axially elongated heel flange, a first lip, and a second lip defining an annular recess that bisects the central axis, wherein a radial midpoint of the axially elongated heel flange is radially offset from the central axis, a radial midpoint of the first lip, and a radial midpoint of the second lip.

### CROSS-REFERENCE TO RELATED APPLICATION(S)

This application claims priority under 35 U.S.C. § 119(c) to U.S. Provisional Application No. 63/476,004, entitled “SEALS AND METHODS OF MAKING AND USING THE SAME,” by Roberto CANNIOTO, filed Dec. 19, 2022, which is assigned to the current assignee hereof and incorporated herein by reference in its entirety.

### FIELD OF THE DISCLOSURE

The present disclosure relates to seals, and more particularly to annular seals.

### RELATED ART

Seals are employed in environments to segregate fluids (liquids, gases, slurries, etc.) from one another. Often, these seals may be used in situations such as, but not limited to, ball valves for oil and gas applications. Often, these seals must show minimal leakage under strict friction requirements in broad temperature and pressure ranges. The industry continues to demand improved seals capable of withstanding broader pressure and temperature conditions while maintaining operational effectiveness over time.

### SUMMARY

Embodiments herein may include a seal including: a metal annular body oriented down a central axis, the metal annular body including an axially elongated heel flange, a first lip, and a second lip defining an annular recess that bisects the central axis, where a radial midpoint of the axially elongated heel flange is radially offset from the central axis, a radial midpoint of the first lip, and a radial midpoint of the second lip.

Embodiments herein may include a seal including: a metal annular body oriented down a central axis, the metal annular body including an axially elongated heel flange defining a cavity, a first lip, and a second lip defining an annular recess that bisects the central axis; and a washer disposed within the cavity of the axially elongated heel flange, where a radial midpoint of the washer is radially offset from the central axis, a radial midpoint of the first lip, and a radial midpoint of the second lip.

Embodiments herein may include a seal including: a first member; a second member; and a seal disposed between the first member and the second member, the seal including: a metal annular body oriented down a central axis, the metal annular body including an axially elongated heel flange, a first lip, and a second lip defining an annular recess that bisects the central axis, where a radial midpoint of the axially elongated heel flange is radially offset from the central axis, a radial midpoint of the first lip, and a radial midpoint of the second lip.

### BRIEF DESCRIPTION OF THE DRAWINGS

Embodiments are illustrated by way of example and are not intended to be limited in the accompanying figures.

FIG. 1A includes a cross-sectional perspective view of a seal in accordance with an embodiment.

FIG. 1B includes a cross-sectional perspective view of a seal in accordance with an embodiment.

FIG. 1C includes a cross-sectional perspective view of a seal in accordance with an embodiment.

FIG. 2 includes a cross-sectional perspective view of a seal assembly in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scaling arts.

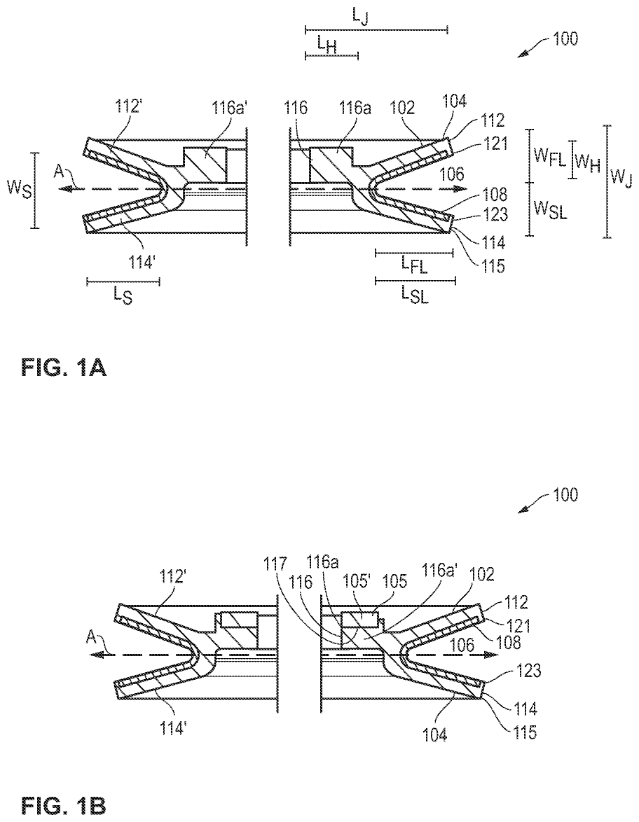

FIGS. 1A, 1B, and 1C illustrate a cross-sectional perspective view of a seal in accordance with a number of embodiments. Referring initially to FIG. 1A, a seal 100 in accordance with some embodiments described herein can be oriented down a central axis A, which runs parallel to the axis of an assembly as described below, and generally includes a jacket 102. The jacket 102 can include a body 104 having a heel 116, a first lip 112, and a second lip 114 defining an annular recess 106. In a number of embodiments, the body 104 may be a metal annular body. In a number of embodiments, the seal may further include an energizer 108 disposed or housed within the annular recess 106. In a number of embodiments, the seal 100 may further include a washer 105. In a number of embodiments, the washer 105 may be disposed within a cavity of the heel 116 as described below.

The seal 100 (including at least one of the jacket 102, washer 105, or the energizer 108) can be formed from any suitable material in the sealing arts. In a particular embodiment, the seal 100 (including at least one of the jacket 102, washer 105, or the energizer 108) can at least partially include a polymer. The polymer may be selected from the group including a polyketone, a polyaramid, a polyphenylene sulfide, a polyethersulfone, a polyphenylene sulfone, a polyamideimide, ultra high molecular weight polyethylene, a fluoropolymer, a polybenzimidazole, a polyacetal, polybutylene terephthalate (PBT), polypropylene (PP), polycarbonate (PC), Acrylonitrile butadiene styrene (ABS), polyethylene terephthalate (PET), a polyimide (PI), polyetherimide, polyetheretherketone (PEEK), polyethylene (PE), a polysulfone, a polyamide (PA), polyphenylene oxide, polyphenylene sulfide (PPS), a polyurethane, a polyester, a liquid crystal polymer (LCP), elastomer, or any combination thereof. The polymer may be a thermoplastic or thermosetting polymer. In an embodiment, the jacket 102 may include, or even consist essentially of, a fluoropolymer. Exemplary fluoropolymers include a polytetrafluoroethylene (PTFE), a polyether ether ketone (PEEK), a polyimide (PI), a polyamideimide (PAI), a fluorinated ethylene propylene (FEP), a polyvinylidene fluoride (PVDF), a perfluoroalkoxy (PFA), a terpolymer of tetrafluoroethylene, a hexafluoropropylene and vinylidene fluoride (THV), a polychlorotrifluoroethylene (PCTFE), an ethylene tetrafluoroethylene copolymer (ETFE), an ethylene chlorotrifluoroethylene copolymer (ECTFE), or any combination thereof. Other fluoropolymers, polymers, and blends may be included in the composition of the jacket 102. In another particular embodiment, the seal 100 (including at least one of the jacket 102, washer 105, or the energizer 108) can at least partially include, or even consist essentially of, a polyethylene (PE) such as an ultra-high-molecular-weight polyethylene (UHMWPE). In another particular embodiment, the seal 100 (including at least one of the jacket 102, washer 105, or the energizer 108) may include a thermoplastic elastomeric hydrocarbon block copolymer, a polyether-ester block co-polymer, a thermoplastic polyamide elastomer, a thermoplastic polyurethane elastomer, a thermoplastic polyolefin elastomer, a thermoplastic vulcanizate, an olefin-based co-polymer, an olefin-based ter-polymer, a polyolefin plastomer, or combinations thereof. In an embodiment, the seal 100 (including at least one of the jacket 102, washer 105, or the energizer 108) may include a styrene based block copolymer such as styrene-butadiene, styrene-isoprene, blends or mixtures thereof, and the like. Exemplary styrenic thermoplastic elastomers include triblock styrenic block copolymers (SBC) such as styrene-butadiene-styrene (SBS), styrene-isoprene-styrene (SIS), styrene-ethylene butylene-styrene (SEBS), styrene-ethylene propylene-styrene (SEPS), styrene-ethylene-ethylene-butadiene-styrene (SEEBS), styrene-ethylene-ethylene-propylene-styrene (SEEPS), styrene-isoprene-butadiene-styrene (SIBS), or combinations thereof. Commercial examples include some grades of Kraton™ and Hybrar™ resins. In an embodiment, the seal 100 (including at least one of the jacket 102, washer 105, or the energizer 108) may include an elastomer including at least one of Acrylonitrile-Butadiene (NBR), Carboxylated Nitrile (XNBR), Ethylene Acrylate (AEM, Vamac®), Ethylene Propylene Rubber (EPR, EPDM), Butyl Rubber (IIR), Chloroprene Rubber (CR), Fluorocarbon (FKM, FPM), Fluorosilicone (FVMQ). Hydrogenated Nitrile (HNBR), Perfluoroclastomer (FFKM), Polyacrylate (ACM). Polyurethane (AU, EU), Silicone Rubber (Q, MQ, VMQ, PVMQ), Tetrafluoroethylene-Propylene (AFLAS®) (FEPM).

In an embodiment, the seal 100 (including at least one of the jacket 102, washer 105, or the energizer 108) can be treated, impregnated, filled, or coated with a lubricious material. Exemplary lubricious materials include molybdenum disulfide, tungsten disulfide, graphite, grapheme, expanded graphite, boron nitrade, talc, calcium fluoride, or any combination thereof. Additionally, the lubricious material can include alumina, silica, titanium dioxide, calcium fluoride, boron nitride, mica, Wollastonite, silicon carbide, silicon nitride, zirconia, carbon black, pigments, or any combination thereof.

In an embodiment, the seal 100 (including at least one of the jacket 102, washer 105, or the energizer 108) can at least partially include a metal. According to certain embodiments, the metal may include iron, copper, titanium, tin, aluminum, alloys thereof, or may be another type of metal. In an embodiment, the seal 100 (including at least one of the jacket 102, washer 105, or the energizer 108) can include a metal (such as aluminum, zinc, copper, magnesium, tin, platinum, titanium, tungsten, iron, bronze, steel, energizer steel, stainless steel, spring steel, ferrous alloy, non-ferrous alloy, nickel, Eligloy, Inconel, Hastelloy), a metal alloy (including the metals listed), an anodized metal (including the metals listed) or any combination thereof. In an embodiment, the washer 105 may be hard polymer or coated metal ring as described herein.

In an embodiment, the seal 100 (including at least one of the jacket 102, washer 105, or the energizer 108) may be coated with a coating 115. The coating 115 may be a low friction coating containing a low friction material. In a number of embodiments, the low friction material can comprise materials including, for example, a polymer, such as a polyketone, a polyaramid, a polyimide, a polyetherimide, a polyphenylene sulfide, a polyethersulfone, a polysulfone, a polyphenylene sulfone, a polyamideimide, ultra high molecular weight polyethylene, a fluoropolymer, a polyamide, a polybenzimidazole, or any combination thereof. In an example, the low friction material includes a polyketone, a polyaramid, a polyimide, a polyetherimide, a polyamideimide, a polyphenylene sulfide, a polyphenylene sulfone, a fluoropolymer, a polybenzimidazole, a derivation thereof, or a combination thereof. In a particular example, the low friction/wear resistant layer includes a polymer, such as a polyketone, a thermoplastic polyimide, a polyetherimide, a polyphenylene sulfide, a polyether sulfone, a polysulfone, a polyamideimide, a derivative thereof, or a combination thereof. In a further example, the low friction/wear resistant layer includes polyketone, such as polyether ether ketone (PEEK), polyether ketone, polyether ketone ketone, polyether ketone ether ketone, a derivative thereof, or a combination thereof. In an additional example, the low friction/wear resistant layer may be an ultra high molecular weight polyethylene. An example fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene and vinylidene fluoride (THV), polychlorotrifluoroethylene (PCTFE), ethylene tetrafluoroethylene copolymer (ETFE), ethylene chlorotrifluoroethylene copolymer (ECTFE), polyacetal, polybutylene terephthalate (PBT), polyethylene terephthalate (PET), polyimide (PI), polyetherimide, polyetheretherketone (PEEK), polyethylene (PE), polysulfone, polyamide (PA), polyphenylene oxide, polyphenylene sulfide (PPS), polyurethane, polyester, liquid crystal polymers (LCP), or any combination thereof. The low friction material may include a solid based material including lithium soap, graphite, boron nitride, molybdenum disulfide, tungsten disulfide, polytetrafluoroethylene, carbon nitride, tungsten carbide, or diamond like carbon, a metal (such as aluminum, zinc, copper, magnesium, tin, platinum, titanium, tungsten, lead, iron, bronze, steel, spring steel, stainless steel), a metal alloy (including the metals listed), an anodized metal (including the metals listed) or any combination thereof. Fluoropolymers may be used according to particular embodiments. As used herein, a “low friction material” can be a material having a dry static coefficient of friction as measured against steel of less than 0.5, such as less than 0.4, less than 0.3, or even less than 0.2. A “high friction material” can be a material having a dry static coefficient of friction as measured against steel of greater than 0.6, such as greater than 0.7, greater than 0.8, greater than 0.9, or even greater than 1.0.

In a number of embodiments, the low friction material may further include fillers, including glass fibers, carbon fibers, silicon, PEEK, aromatic polyester, carbon particles, bronze, fluoropolymers, thermoplastic fillers, aluminum oxide, polyamideimide (PAI), PPS, polyphenylene sulfone (PPSO2), LCP, aromatic polyesters, molybdenum disulfide, tungsten disulfide, graphite, grapheme, expanded graphite, boron nitrade, talc, calcium fluoride, or any combination thereof. Additionally, the filler can include alumina, silica, titanium dioxide, calcium fluoride, boron nitride, mica, Wollastonite, silicon carbide, silicon nitride, zirconia, carbon black, pigments, or any combination thereof. Fillers can be in the form of beads, fibers, powder, mesh, or any combination thereof.

In an embodiment, the coating 115 can have a thickness in a range of 0.01 mm and 1.5 mm, such as in a range of 0.15 mm and 1.35 mm, or even in a range of 0.2 mm and 1.25 mm. In an embodiment, the thickness of the coating 115 may be uniform, i.e., a thickness at a first location of the coating 115 can be equal to a thickness at a second location therealong. In an embodiment, the seal 100 (including at least one of the jacket 102, washer 105, or the energizer 108) may be at least partially encapsulated by the coating 115.

In an embodiment, the coating 115 may be applied using a coating technique, such as, for example, physical or vapor deposition, spraying, plating, powder coating, or through other chemical or electrochemical techniques. In a particular embodiment, the coating 115 may be applied by a roll-to-roll coating process, including for example, extrusion coating. The low coating 115 may be heated to a molten or semi-molten state and extruded through a slot die onto a major surface of the seal 100. In another embodiment, the coating 115 may be cast or molded.

In yet another embodiment, the coating 115 may be applied through use of an adhesive. Optionally, the seal 100 may include at least one adhesive layer that may couple the coating 115 to the seal 100. The adhesive layer may include any known adhesive material common to the ring arts including, but not limited to, fluoropolymers, epoxy resins, polyimide resins, polyether/polyamide copolymers, ethylene vinyl acetates, ethylene tetrafluoroethylene (ETFE), ETFE copolymer, perfluoroalkoxy (PFA), or any combination thereof. Additionally, the adhesive can include at least one functional group selected from —C═O, —C—O—R, —COH, —COOH, —COOR, —CF₂═CF—OR, or any combination thereof, where R is a cyclic or linear organic group containing between 1 and 20 carbon atoms. Additionally, the adhesive can include a copolymer. In an embodiment, the hot melt adhesive can have a melting temperature of not greater than 250° C., such as not greater than 220° C. In another embodiment, the adhesive may break down above 200° C., such as above 220° C. In further embodiments, the melting temperature of the hot melt adhesive can be higher than 250° C. or even higher than 300° C. The adhesive layer can have a thickness of about 1 to 50 microns, such as about 7 to 15 microns. In particular embodiments, the washer may be a metal substrate with a polytetrafluoroethylene coating.

As stated above, the seal 100 may include a jacket 102. The jacket 102 may include a plurality of lips 112, 114 defining an annular recess 106. The recess 106 may be U-shaped, C-shaped, or V-shaped in cross-section. In a particular instance, the lips 112 and 114 can extend from the heel 116 of the body 104. In a particular embodiment, the lips 112 and 114 can extend from the heel 116 in a generally same direction relative to one another. In an embodiment, the first lip 112 may be located exterior to the second lip 114. In another particular embodiment, the lips 112 and 114 can extend parallel with respect to one another. In an optional embodiment, either or both of the lips 112 and 114 can include a skived lip (not illustrated) adapted to provide a scraper interface for sealing abrasive or viscous material, or environmental components such as dirt, debris, and environmental fluids.

In an embodiment, at least one of the lips 112 and 114 can be generally planar profile extending from the heel 116. In an embodiment, at least one of the lips 112 and 114 can include a bulge extending outward from the respective lip 112 or 114 in a direction away from the annular recess 106, resulting in an arcuate shape. The bulge may extend around an entire circumference of the seal 100. Similar to the skived lip described above, the bulge may prevent ingress or egress of materials while exhibiting lower frictional drag. In another embodiment, one of the lips 112 or 114 can include a skived lip and the other lip 112 or 114 can include a bulge. In an embodiment, at least one of the lips 112 and 114 can include a rectilinear or planar shape.

Upon a loading condition, the energizer 108 may deform in an axial direction in the axial height of the seal 100 so as to contact or even push against a lip 112, 114 of the jacket 102. Resultantly, the lips 112, 114 may provide an outward force against a neighboring component (e.g. first and second member respectively) within an assembly. Meanwhile, the lips 112 and 114, compressed between the first and second member, may bias the energizer 108 in a direction transverse to the axial height of the seal 100, thus generating generally four biasing force directions, two inward axial forces and two opposing outward axial forces. The force provided by the energizer 108 on either lip 112, 114 may be different than the force provided by the first or second member. It is noted that the biasing forces described may be indirectly loaded against the energizer 108 in particular applications.

As illustrated, the lips 112 and 114 of the jacket 102 can bow outward after installation of the energizer 108. After installation of the energizer 108, at least one of the lips 112 and 114 can be arcuate as viewed in cross section, biased outward by a biasing force provided by the energizer 108. After installation of the energizer 108, at least one of the lips 112 and 114 can be rectilinear or planar as viewed in cross section, biased outward by a biasing force provided by the energizer 108 or a neighboring component. In a number of embodiments, the energizer 108 provides a radial biasing force against the first lip and the second lip of between 20 and 1500 N/mm.

As shown in FIGS. 1A-IC, the first lip 112 may include a planar, rectilinear, or flat profile along its inner surface (facing the recess) and a planar, rectilinear, or flat profile along its outer surface (facing the neighboring component). Further, as shown in FIG. 1A, the second lip 114 may include a planar, rectilinear, or flat profile along its inner surface (facing the recess) and a planar, rectilinear, or flat profile along its outer surface (facing the neighboring component).

In an embodiment, at least one of the first lip 112 or the second lip 114 may include an arcuate profile. In an embodiment, at least one of the first lip 112 or the second lip 114 may include a planar section and an arcuate section.

In an embodiment, at least one of the first lip 112 or the second lip 114 may include an oriented flange 121, 123. In some embodiments, the oriented flange 121, 123 may be arcuate as viewed in cross section. In some embodiments, the oriented flange 121, 123 may be rectilinear or planar as viewed in cross section. The oriented flange 121, 123 may include edges on the inside of the flange 121, 123 within the annular recess 106. In a number of embodiments, the oriented flange 121, 123 or at least one of the first lip 112 or the second lip 114 may house the energizer 108 to fix it to body 102 of the seal 100.

In an embodiment, the jacket 102 may have a length L_{J} of at least 0.1 mm, at least 1 mm, at least 5 mm, at least 10 mm, at least 25 mm, at least 50 mm, at least 75 mm, at least 100 mm, at least 150 mm, at least 250 mm, at least 500 mm. The jacket 102 may have a length L_{J} that may be no greater than 5000 mm, no greater than 4000 mm, no greater than 3000 mm, no greater than 2000 mm, no greater than 1500 mm, no greater than 1000 mm. It will be further appreciated that the jacket 102 may have a length L_{J} that may be any value between any of the minimum and maximum values noted above. It can also be appreciated that the jacket 102 may have a length L_{J} that may vary along its circumference. In a number of embodiments, the jacket 102 may have a length L_{J} that may be the same as the overall length, L_{S}, of the seal 100 itself.

In an embodiment, the jacket 102 may have a width W_{J} of at least 0.1 mm, at least 1 mm, at least 5 mm, at least 10 mm, at least 25 mm, at least 50 mm, at least 75 mm, at least 100 mm, at least 150 mm, at least 250 mm, at least 500 mm. The jacket 102 may have a width W_{J} that may be no greater than 5000 mm, no greater than 4000 mm, no greater than 3000 mm, no greater than 2000 mm, no greater than 1500 mm, no greater than 1000 mm. It will be further appreciated that the jacket 102 may have a width W_{J} that may be any value between any of the minimum and maximum values noted above. It can also be appreciated that the jacket 102 may have a width W_{J} that may vary along its circumference. In a number of embodiments, the jacket 102 may have a width W_{J} that may be the same as the overall width, W_{S}, of the seal 100 itself.

In an embodiment, the first lip 112 may have a length L_{FL} of at least 0.1 mm, at least 1 mm, at least 5 mm, at least 10 mm, at least 25 mm, at least 50 mm, at least 75 mm, at least 100 mm, at least 150 mm, at least 250 mm, at least 500 mm. The first lip 112 may have a length L_{FL} that may be no greater than 5000 mm, no greater than 4000 mm, no greater than 3000 mm, no greater than 2000 mm, no greater than 1500 mm, no greater than 1000 mm. It will be further appreciated that the first lip 112 may have a length L_{FL} that may be any value between any of the minimum and maximum values noted above. It can also be appreciated that the first lip 112 may have a length L_{FL} that may vary along its circumference.

In an embodiment, the first lip 112 may have a thickness W_{FL} of at least 0.1 mm, at least 1 mm, at least 5 mm, at least 10 mm, at least 25 mm, at least 50 mm, at least 75 mm, at least 100 mm, at least 150 mm, at least 250 mm, at least 500 mm. The first lip 112 may have a thickness W_{FL} that may be no greater than 5000 mm, no greater than 4000 mm, no greater than 3000 mm, no greater than 2000 mm, no greater than 1500 mm, no greater than 1000 mm. It will be further appreciated that first lip 112 may have a thickness W_{FL} that may be any value between any of the minimum and maximum values noted above. It can also be appreciated that the first lip 112 may have a thickness W_{FL} that may vary along its circumference.

In an embodiment, the first lip 112 may have a ratio of length L_{FL} to thickness W_{HL} of at least 2:1, such as 3:1, such as 4:1, such as 5:1, such as 10:1, such as 12:1, such as 15:1, such as 25:1 or such as 50:1. It will be further appreciated that first lip 112 may have a ratio of length L_{FL} to thickness W_{FL} may be any value between any of the minimum and maximum values noted above. It can also be appreciated that the first lip 112 may have a ratio of length L_{FL} to thickness W_{FL} that may vary along its circumference.

In an embodiment, the second lip 114 may have a length L_{SL} of at least 0.1 mm, at least 1 mm, at least 5 mm, at least 10 mm, at least 25 mm, at least 50 mm, at least 75 mm, at least 100 mm, at least 150 mm, at least 250 mm, at least 500 mm. The second lip 114 may have a length L_{SL} that may be no greater than 5000 mm, no greater than 4000 mm, no greater than 3000 mm, no greater than 2000 mm, no greater than 1500 mm, no greater than 1000 mm. It will be further appreciated that the second lip 114 may have a length L_{SL} that may be any value between any of the minimum and maximum values noted above. It can also be appreciated that the second lip 114 may have a length L_{SL} that may vary along its circumference.

In an embodiment, the second lip 114 may have a thickness W_{SL} of at least 0.1 mm, at least 1 mm, at least 5 mm, at least 10 mm, at least 25 mm, at least 50 mm, at least 75 mm, at least 100 mm, at least 150 mm, at least 250 mm, at least 500 mm. The second lip 114 may have a thickness W_{SL} that may be no greater than 5000 mm, no greater than 4000 mm, no greater than 3000 mm, no greater than 2000 mm, no greater than 1500 mm, no greater than 1000 mm. It will be further appreciated that second lip 114 may have a thickness W_{SL} that may be any value between any of the minimum and maximum values noted above. It can also be appreciated that the second lip 114 may have a thickness W_{SL} that may vary along its circumference.

In an embodiment, the second lip 114 may have a ratio of length L_{SL} to thickness W_{SL} of at least 2:1, such as 3:1, such as 4:1, such as 5:1, such as 6:1, such as 7:1, such as 10:1, such as 12:1, such as 15:1, such as 25:1 or such as 50:1. It will be further appreciated that second lip 114 may have a ratio of length L_{SL} to thickness W_{SL} may be any value between any of the minimum and maximum values noted above. It can also be appreciated that the second lip 114 may have a ratio of length L_{SL} to thickness W_{SL} that may vary along its circumference. In a number of embodiments, as shown in FIGS. 1A-1B, the thicknesses of the two lips 112, 114 may differ.

Still referring to FIGS. 1A-1C, in a number of embodiments, the jacket 102 may include a heel 116. In an embodiment, the heel 116 of the jacket 102 can be generally rectilinear or planar. That is, the heel 116 may lie generally along a plane with minimal surface undulation and deviation. In a more particular embodiment, the heel 116 of the jacket 102 can be planar. As described in greater detail below, the planar, or generally planar, heel 116 of the jacket 102 may facilitate improved contact between adjacent seals thereby providing a better scaling characteristic. In a particular embodiment, the heel 116 can include a catch (not illustrated) which can be secured to a hardware (e.g., a valve housing or a shaft) to prevent the seal 100 from turning relative to the hardware within an assembly.

In a number of embodiments, the heel 116 may include an axially elongated heel flange 116a. In a number of embodiments the axially elongated heel flange 116a may have a rectilinear or polygonal cross-section. In a number of embodiments the axially elongated heel flange 116a may have an arcuate cross-section. In a number of embodiments the axially elongated heel flange 116a may have a rectilinear cross-section. In a number of embodiments the axially elongated heel flange 116a may have a rectangular cross-section. In a number of embodiments the axially elongated heel flange 116a may have a square cross-section.

In a number of embodiments, as shown in FIGS. 1A-IC, the axially elongated heel flange 116a may have a radial midpoint 116a′ relative to the central axis A. The first lip 112 may have a radial midpoint 112′ relative to the central axis A. The second lip 114 may have a radial midpoint 114′ relative to the central axis A. In a number of embodiments, the radial midpoint 116a′ of the axially elongated heel flange 116a may be radially offset from the central axis A, the radial midpoint 112′ of the first lip 112, and a radial midpoint 114′ of the second lip 114. In a number of embodiments, the radial midpoint 116a′ of the axially oriented heel flange 116a may be disposed closer to a radial midpoint 112′ of the first lip 112. In a number of embodiments, the radial midpoint 116a′ of the axially oriented heel flange 116a may be disposed closer to a radial midpoint 114′ of the second lip 114.

In a number of embodiments, as shown best in FIG. 1B, the axially elongated heel flange 116a may define a cavity 117. A washer 105 may be disposed within this cavity 117. In this case a radial midpoint 105′ of the washer 105 may be radially offset from the central axis A, the radial midpoint 112′ of the first lip 112, and a radial midpoint 114′ of the second lip 114. In a number of embodiments, the cavity 117 may have an arcuate in cross-section. In a number of embodiments, the cavity 117 may have a rectilinear in cross-section. In a number of embodiments the cavity 117 may have a rectangular cross-section. In a number of embodiments the axially cavity 117 may have a square cross-section. In a number of embodiments, the elongated heel 116a may have at least one corrugation, edge, or surface roughness that contacts the washer 105 to provide an interference fit therebetween.

In an embodiment, the heel 116 may have a length L_{H} of at least 0.1 mm, at least 0.5 mm, at least 1 mm, at least 5 mm, at least 10 mm, at least 25 mm, at least 50 mm, at least 75 mm, at least 100 mm, at least 150 mm, at least 250 mm, at least 500 mm. The heel 116 may have a length L_{H} that may be no greater than 5000 mm, no greater than 4000 mm, no greater than 3000 mm, no greater than 2000 mm, no greater than 1500 mm, no greater than 1000 mm. It will be further appreciated that the heel 116 may have a length L_{H} that may be any value between any of the minimum and maximum values noted above. It can also be appreciated that the heel 116 may have a length L_{H} that may vary along its circumference.

In an embodiment, the heel 116 may have a thickness W_{H} of at least 0.1 mm, at least 1 mm, at least 5 mm, at least 10 mm, at least 25 mm, at least 50 mm, at least 75 mm, at least 100 mm, at least 150 mm, at least 250 mm, at least 500 mm. The heel 116 may have a thickness W_{H} that may be no greater than 5000 mm, no greater than 4000 mm, no greater than 3000 mm, no greater than 2000 mm, no greater than 1500 mm, no greater than 1000 mm. It will be further appreciated that heel 116 may have a thickness W_{H} that may be any value between any of the minimum and maximum values noted above. It can also be appreciated that the heel 116 may have a thickness W_{H} that may vary along its circumference.

In an embodiment, the heel 116 may have a ratio of length L_{H} to thickness W_{H} of at least 1:1, such as 1:2, such as 1:5, such as 1:10, such as 1:15, such as 1:25, such as 1:50. In an embodiment, the heel 116 may have a ratio of length L_{H} to thickness W_{H} of at least 2:1, such as 2.1:1, such as 2.2:1, such as 2.5:1, such as 3:1, such as 4:1, such as 5:1, such as 10:1, such as 12:1, such as 15:1, such as 25:1 or such as 50:1. It will be further appreciated that heel 116 may have a ratio of length L_{H} to thickness W_{H} may be any value between any of the minimum and maximum values noted above. It can also be appreciated that the heel 116 may have a ratio of length L_{H} to thickness W_{H} that may vary along its circumference.

In an embodiment, the seal 100 may have a ratio of length L_{FL} of the first lip 112 to length L_{H} of the heel 116 of at least 2:1, such as 3:1, such as 4:1, such as 5:1, such as 10:1, such as 12:1, such as 15:1, such as 25:1 or such as 50:1. In an embodiment, the seal 100 may have a ratio of length L_{FL} of the first lip 112 to length L_{H} of the heel 116 of at least 1:2, such as 1:3, such as 1:5, such as 1:10, such as 1:12, such as 1:15, such as 1:25 or such as 1:50. It will be further appreciated that seal 100 may have a ratio of length L_{FL} of the first lip 112 to length L_{H} of the heel 116 which may be any value between any of the minimum and maximum values noted above. It can also be appreciated that seal 100 may have a ratio of length L_{FL} of the first lip 112 to length L_{H} of the heel 116 that may vary along its circumference.

In an embodiment, the seal 100 may have a ratio of width W_{FL} of the first lip 112 to width W_{H} of the heel 116 of at least 2:1, such as 3:1, such as 4:1, such as 5:1, such as 10:1, such as 12:1, such as 15:1, such as 25:1 or such as 50:1. In an embodiment, the seal 100 may have a ratio of width W_{FL} of the first lip 112 to width W_{H} of the heel 116 of at least 1:2, such as 1:3, such as 1:5, such as 1:10, such as 1:12, such as 1:15, such as 1:25 or such as 1:50. It will be further appreciated that seal 100 may have a ratio of width W_{FL} of the first lip 112 to width W_{H} of the heel 116 which may be any value between any of the minimum and maximum values noted above. It can also be appreciated that seal 100 may have a ratio of width W_{FL} of the first lip 112 to width W_{H} of the heel 116 that may vary along its circumference.

In an embodiment, the seal 100 may have a ratio of length L_{SL} of the second lip 114 to length L_{H} of the heel 116 of at least 2:1, such as 3:1, such as 4:1, such as 5:1, such as 10:1, such as 12:1, such as 15:1, such as 25:1 or such as 50:1. In an embodiment, the seal 100 may have a ratio of length L_{SL} of the second lip 114 to length L_{H} of the heel 116 of at least 1:2, such as 1:3, such as 1:5, such as 1:10, such as 1:12, such as 1:15, such as 1:25 or such as 1:50. It will be further appreciated that seal 100 may have a ratio of length L_{SL} of the second lip 114 to length L_{H} of the heel 116 which may be any value between any of the minimum and maximum values noted above. It can also be appreciated that seal 100 may have a ratio of length L_{SL} of the second lip 114 to length L_{H} of the heel 116 that may vary along its circumference.

In an embodiment, the seal 100 may have a ratio of width W_{SL} of the second lip 114 to width W_{H} of the heel 116 of at least 2:1, such as 3:1, such as 4:1, such as 5:1, such as 10:1, such as 12:1, such as 15:1, such as 25:1 or such as 50:1. In an embodiment, the seal 100 may have a ratio of width W_{SL} of the second lip 114 to width W_{H} of the heel 116 of at least 1:2, such as 1:3, such as 1:5, such as 1:10, such as 1:12, such as 1:15, such as 1:25 or such as 1:50. It will be further appreciated that seal 100 may have a ratio of width W_{SL} of the second lip 114 to width W_{H} of the heel 116 which may be any value between any of the minimum and maximum values noted above. It can also be appreciated that seal 100 may have a ratio of width W_{SL} of the second lip 114 to width W_{H} of the heel 116 that may vary along its circumference.

As shown in FIGS. 1A-1C and as recited above, the seal may include an energizer 108. In a number of embodiments, the energizer 108 can be disposed at least partially within the annular recess 106 of the jacket 102. The energizer 108 may be an axially oriented energizer in the annular recess 106 of the jacket 102. In an embodiment, the energizer 108 may be disposed along, adjacent, or directly adjacent to the first lip 112. In an embodiment, the energizer 108 may be disposed along, adjacent, or directly adjacent to the second lip 114.

In an embodiment, as shown in FIG. 1A, the energizer 108 may be a U-shaped, C-shaped, or V-shaped cross-sectional spring oriented circumferentially within the recess 106 of the jacket 102. In an embodiment, the energizer 108 may have a diameter less than 150% the depth of the annular recess 106, such as less than 100% of the depth of the annular recess 106, or even less than 75% of the depth of the annular recess 106. In an embodiment, the diameter of the energizer 108 can be no less than 10% of the depth of the annular recess 106.

As contemplated in at least one embodiment described herein, the energizer 108 can be a coil spring that includes a length of material formed into a helical spring having a plurality of coils. In an embodiment, the energizer 108 can include at least 2 coils, such as at least 3 coils, at least 4 coils, at least 5 coils, at least 10 coils, at least 100 coils, at least 200 coils, at least 300 coils, at least 400 coils, at least 500 coils, or even at least 1000 coils. The length of material forming the energizer 108 can have a polygonal or ellipsoidal cross section. For example, in an embodiment, the energizer 108 can be formed from circular wire. In another embodiment, the energizer 108 can be formed from a ribbon of material wound into a plurality of coils. The coils of the energizer 108 can be adjacent or even partially overlap one another. In a particular instance the coils can be parallel to one another. In another instance, the coils can cant relative to each other. That is, the coils can be angularly offset and angled with respect to one another.

In the relaxed state, the energizer 108 may have a generally round cross section. That is, the energizer 108 may be a helical spring, as described above. In other embodiments, the energizer 108 may define a generally polygonal cross-sectional profile. In a more particular embodiment, the energizer 108 may have a generally T-shaped cross-sectional profile. In another embodiment, the energizer 108 may have an ellipsoidal cross section. For example, in a non-illustrated embodiment, the energizer 108 may have an ovular or circular cross-sectional profile. In yet a further embodiment, the cross section of the energizer 108 may be partially ellipsoidal and partially polygonal. That is, the cross section of the energizer 108 may have linear portions and arcuate portions. The wire forming the coil of the energizer 108 may be rectangular, square, circular, elliptical, or keystone in cross section. The wire forming the coil of the energizer 108 may be turned at a pitch of between 0.025 mm and 25.4 mm, such as between 0.1 mm and 3 mm. The wire forming the coil of the energizer 108 may have a wire diameter of between 0.025 mm and 25.4 mm, such as between 0.05 mm and 0.6 mm. The wire forming the coil of the energizer 108 may have an energizer diameter of between 0.05 mm and 40,000 mm, such as between 0.5 mm and 20 mm.

In an embodiment, the energizer 108 may have a length L_{S} of at least 0.1 mm, at least 1 mm, at least 5 mm, at least 10 mm, at least 25 mm, at least 50 mm, at least 75 mm, at least 100 mm, at least 150 mm, at least 250 mm, at least 500 mm. The energizer 108 may have a length L_{S} that may be no greater than 5000 mm, no greater than 4000 mm, no greater than 3000 mm, no greater than 2000 mm, no greater than 1500 mm, no greater than 1000 mm. It will be further appreciated that the energizer 108 may have a length L_{S} that may be any value between any of the minimum and maximum values noted above. It can also be appreciated that the energizer 108 may have a length L_{S} that may vary along its circumference.

In an embodiment, the energizer 108 may have a thickness W_{S} of at least 0.05 mm, at least 1 mm, at least 5 mm, at least 10 mm, at least 25 mm, at least 50 mm, at least 75 mm, at least 100 mm, at least 150 mm, at least 250 mm, at least 500 mm. The energizer 108 may have a thickness W_{S} that may be no greater than 5000 mm, no greater than 4000 mm, no greater than 3000 mm, no greater than 2000 mm, no greater than 1500 mm, no greater than 1000 mm. It will be further appreciated that energizer 108 may have a thickness W_{S} that may be any value between any of the minimum and maximum values noted above. It can also be appreciated that energizer 108 may have a thickness W_{S} that may vary along its circumference.

In an embodiment, the energizer 108 may have a ratio of length L_{S} to thickness W_{S} of at least 10:9, such as 6:5, such as 4:3, such as 2:1, such as 3:1, such as 4:1, such as 5:1, such as 10:1, such as 12:1, such as 15:1, such as 25:1 or such as 50:1. It will be further appreciated that energizer 108 may have a ratio of length L_{S} to thickness W_{S} may be any value between any of the minimum and maximum values noted above. It can also be appreciated that the energizer 108 may have a ratio of length L_{S} to thickness W_{S} that may vary along its circumference.

The energizer 108 may be arcuate as viewed in cross section. In some embodiments, the energizer 108 may be rectilinear or planar as viewed in cross section. As shown in FIG. 1A, the energizer 108 may contact at least one of the lips 112, 114 of the jacket 102. In an embodiment, the energizer 108 may contact substantially the entirety of at least one of the lips 112, 114 in the axial direction. As shown in FIG. 1B, in an embodiment, the energizer 108 may embed within at least one of the annular flanges the lips 112, 114 of the jacket 102. In an embodiment, the energizer 108 may contact at least one of the oriented flanges 121, 123 the lips 112, 114 of the jacket 102. In an embodiment, the energizer 108 may contact substantially the entirety of at least one of the lips 112, 114 of the jacket 102.

In the relaxed state, the energizer 108 may have a generally round U shaped cross section. That is, the energizer 108 may be a helical energizer, as described above. In other embodiments, the energizer 108 may define a generally polygonal cross-sectional profile. In yet a further embodiment, the cross section of the energizer 108 may be partially ellipsoidal and partially polygonal. That is, the cross section of the energizer 108 may have linear portions and arcuate portions.

In an embodiment, the energizer 108 may extend around the entire circumference of the seal 100. In a more particular embodiment, the energizer 108 may have a uniform shape and material characteristic around the entire circumference of the seal 100. In another more particular embodiment, the energizer 108 may have a varying shape or material selection around the circumference of the seal 100. In another embodiment, the energizer 108 may extend around only a portion of the circumference of the seal 100. In a more particular embodiment, the energizer 108 may comprise a plurality of energizers 108 at least partially spaced apart from one another. In such embodiment, there may be a circumferential space between adjacent energizers 108.

The energizer 108 can at least partially include, or even consist essentially of, a metal, such as a steel, or even more particularly energizer steel. The metal can be coated or surface treated to prevent corrosion or another undesirable effect from environmental exposure. In another embodiment, the energizer 108 can at least partially include, or even consist essentially of, for example, Eligloy, Inconel, Hastelloy, or a combination thereof.

In yet a further embodiment, the energizer 108 can include cobalt, chromium, nickel, iron, molybdenum, manganese, beryllium copper, or a combination thereof. In a particular embodiment, the energizer 108 can include at least 10 wt % of cobalt, such as at least 20 wt % of cobalt, at least 25 wt % of cobalt, at least 30 wt % of cobalt, at least 35 wt % of cobalt, or even at least 40 wt % of cobalt. The energizer 108 can have a yield strength of less than 1200 MPa, such as less than 1100 MPa, less than 1000 MPa, or even less than 900 MPa. In a particular instance, the energizer 108 may be heat treated or surface treated to enhance properties thereof.

The energizer 108 may provide a biasing force against the jacket 102. Specifically, the energizer 108 may contact at least one of the first lip 112 or the second lip 114 and provide an outwardly biasing force, F_{E}, thereagainst. In a particular embodiment, the biasing force, F_{E}, of the energizer 108 against a lip 112, 114 can be at least 0.001 N/mm circumference, such as at least 0.05 N/mm circumference. In another embodiment, the biasing force, F_{E}, can be less than 5000 N/mm, less than 1000 N/mm circumference, less than 500 N/mm circumference, less than 400 N/mm circumference, less than 300 N/mm circumference, less than 200 N/mm circumference, less than 100 N/mm circumference, less than 50 N/mm circumference, less than 25 N/mm circumference, less than 10 N/mm circumference, or even less than 2 N/mm circumference, less than 0.5 N/mm circumference, or even less than 0.1 N/mm circumference. In a number of embodiments, the biasing force, F_{E}, against the first lip 112 may be different than the biasing force, F_{E}, against the second lip 114.

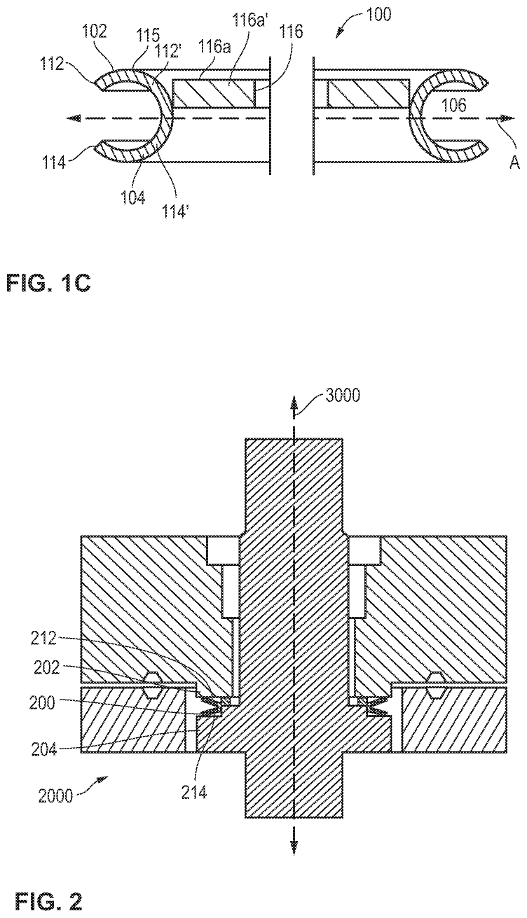

FIG. 2 includes a cross-sectional perspective view of a seal within a seal assembly in accordance with an embodiment. Although FIG. 2 illustrates the seal 200 in an axial orientation, the seal 200 could be oriented in any potential orientation including radial or face sealing orientations. The seal 200 may have the same components listed above regarding FIGS. 1A-IC. As shown in FIG. 2, the seal 200 may be placed between a first member 202 and a second member 204 within a seal assembly 2000 down a central axis 3000 of the seal assembly 2000. In a number of embodiments, the central axis 3000 of the assembly 2000 may be perpendicular to the central axis A described above. The first member 202 may be a shaft or stem. The second member 204 may be a housing or body. At least one of the first member 202 or second member 204 may actuate relative to at least one of the seal 200 or the other of the first member 202 or second member 204. The actuation may be a rotational, radial, or axial movement. The components of the seal 200 of FIG. 2 may be the same as those described above in any of FIGS. 1A-1C. In an embodiment, at least one of the first or second lip 212, 214 may be static while the other of the first or second lip 212, 214 may be dynamic within the seal assembly. In an embodiment, the first lip 212 may be located radially exterior to the second lip 214. This may cause unwanted pressure against the seal 200. Further, the first member 202 may be made of a material having a different expansion coefficient than the second member 204 or vice versa. This may cause unwanted pressure against the seal 200.

The seal 200 may provide a biasing contact force, F_{S}, against at least one of first member 202 or the second member 204. Specifically, the seal 200 may provide a biasing force, F_{S}, against at least one of first member 202 or the second member 204, thereagainst. In a particular embodiment, the seal 200 may provide a biasing force, F_{S}, against at least one of first member 202 or the second member 204 can be at least 0.001 N/mm circumference, such as at least 0.005 N/mm circumference, such as at least 0.01 N/mm circumference, or such as at least 0.05 N/mm circumference. In another embodiment, the biasing force, F_{S}, can be less than 5000 N/mm circumference, such as less than 1000 N/mm circumference, such as less than 500 N/mm circumference, less than 400 N/mm circumference, less than 300 N/mm circumference, less than 200 N/mm circumference, less than 100 N/mm circumference, less than 50 N/mm circumference, less than 25 N/mm circumference, less than 10 N/mm circumference, less than 2 N/mm circumference, or even less than 0.5 N/mm circumference. In a number of embodiments, the biasing force, F_{S}, against the first member 202 may be different than the biasing force, F_{Ss}, against the second member 204.

In an embodiment, the ratio of the biasing force, F_{E}, of the energizer against at least one of the first lip to the biasing force, F_{S}, of the seal against at least one of the first member or second member (e.g. F_{E}:F_{S}) may be at least 1:1, such as 9:10, such as 4:5, such as 7:10, such as 3:5, such as 1:2, such as 1:3, such as 1:4, such as 1:5, such as 1:10, such as 1:12, such as 1:15, such as 1:25. It will be further appreciated that ratio of F_{E}:F_{S} may be any value between any of the minimum and maximum values noted above. It can also be appreciated that ratio of F_{E}:F_{S} that may vary along its circumference.

The seal 200 may have a contact area on at least one of first member 202 or the second member 204. In a particular embodiment, the seal 200 may have a contact area on at least one of first member 202 or the second member 204 of less than 75%, such as less than 50%, such as less than 25%, or such as less than 10% of the total area of the seal 200. In another embodiment, the contact area on at least one of first member 202 or the second member 204 of at least 10%, such as at least 25%, such as at least 50%, such as at least 75%, or such as at least 90% of the total area of the seal 200.

The seal 100, 200 may form an assembly which can be utilized in a bidirectional pressure application. The seal 100, 200 may be oriented and protect against leakage of fluid in a forward axial direction, or the seal 100, 200 may be oriented and protect against leakage of fluid in a backward axial direction down the central axis 3000 of the seal assembly 2000. The seal 100, 200 may be oriented and protect against leakage of fluid in an inward radial direction, or the seal 100 may be oriented and protect against leakage of fluid in an outward radial direction in a direction perpendicular to the central axis 3000 of the seal assembly 2000. In this regard, the seal 100, 200 may be selected to have specific characteristics which permit effective sealing in those particular orientations. The seal 100, 200 may be used in temperature ranges of between −60° C. and 345° C. The seal 100, 200 may be used in pressure ranges of between 69 and 207 MPa. Particular suitable applications include oil and gas seals used in things such as ball valves.

Seals described according to embodiments herein may allow for the components of the seal to have a longer lifetime due to appropriately placed forces that lessen repeat compression and stressing of the individual components (e.g. the energizer, jacket) due to vibration or actuation of the seal or other components within the assembly. As a result, the lifetime of the components and the seal itself may be improved and overall leakage may be lessened. Lastly, the use of the seal may replace conventional seal-washer combinations in similar applications by combining them into a single piece seal as described in embodiments herein, which may reduce tolerances, friction, and torque by approximately 20% compared to conventional solutions.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Embodiment 1. A seal comprising: a metal annular body oriented down a central axis, the metal annular body comprising an axially elongated heel flange, a first lip, and a second lip defining an annular recess that bisects the central axis, wherein a radial midpoint of the axially elongated heel flange is radially offset from the central axis, a radial midpoint of the first lip, and a radial midpoint of the second lip.

Embodiment 2. A seal comprising: a metal annular body oriented down a central axis, the metal annular body comprising an axially elongated heel flange defining a cavity, a first lip, and a second lip defining an annular recess that bisects the central axis; and a washer disposed within the cavity of the axially elongated heel flange, wherein a radial midpoint of the washer is radially offset from the central axis, a radial midpoint of the first lip, and a radial midpoint of the second lip.

Embodiment 3. A seal assembly comprising: a first member; a second member; and a seal disposed between the first member and the second member, the seal comprising: a metal annular body oriented down a central axis, the metal annular body comprising an axially elongated heel flange, a first lip, and a second lip defining an annular recess that bisects the central axis, wherein a radial midpoint of the axially elongated heel flange is radially offset from the central axis, a radial midpoint of the first lip, and a radial midpoint of the second lip.

Embodiment 4. The seal or seal assembly according to any one of the preceding embodiments, wherein the radial midpoint of the axially oriented heel flange is disposed closer to a radial midpoint of the first lip.

Embodiment 5. The seal or seal assembly according to any one of the preceding embodiments, wherein the radial midpoint of the axially oriented heel flange is disposed closer to a radial midpoint of the second lip.

Embodiment 6. The seal or seal assembly according to any one of the preceding embodiments, wherein the seal comprises an energizer housed within the annular recess.

Embodiment 7. The seal or seal assembly according to any one of the preceding embodiments, wherein the energizer provides a radial biasing force against the first lip and the second lip of between 20 and 1500 N/mm.

Embodiment 8. The seal or seal assembly according to any one of the preceding embodiments, wherein the annular recess has a U-shaped, C-shaped, or V-shaped cross-section.

Embodiment 9. The seal assembly according to any one of the preceding embodiments, wherein at least one of the first or second lip is static within the seal assembly.

Embodiment 10. The seal assembly according to any one of the preceding embodiments, wherein at least one of the first or second lip is dynamic within the seal assembly.

Embodiment 11. The seal assembly according to any one of the preceding embodiments, wherein the axially elongated heel flange has a rectilinear cross-section.

Embodiment 12. The seal assembly according to any one of the preceding embodiments, wherein the axially elongated heel flange has a rectangular cross-section.

Embodiment 13. The seal assembly according to any one of the preceding embodiments, wherein the axially elongated heel flange has a square cross-section.

Embodiment 14. The seal or seal assembly according to any one of the preceding embodiments, wherein the first lip is located radially exterior to the second lip.

Embodiment 15. The seal assembly according to any one of the preceding embodiments, wherein the energizer is a coil spring.

Embodiment 16. The seal or seal assembly according to embodiment 11, wherein the energizer is turned at a pitch of between 0.1 and 3 mm.

Embodiment 17. The seal or seal assembly according to embodiment 11, wherein the energizer has a wire diameter of between 0.05 and 0.6 mm.

Embodiment 18. The seal or seal assembly according to embodiment 11, wherein the energizer has an energizer diameter of between 0.5 and 20 mm.

Embodiment 19. The seal assembly according to any one of the preceding embodiments, wherein the energizer has a rectangular, square, or keystone cross-sectional wire.

Embodiment 20. The seal assembly according to any one of the preceding embodiments, wherein the energizer has a circular cross-sectional wire.

Embodiment 21. The seal or seal assembly according to any one of the preceding embodiments, wherein the energizer comprises a metal.

Embodiment 22. The seal or seal assembly according to any one of the preceding embodiments, wherein the metal annular body comprises a steel, ferrous, Inconel, and non-ferrous (nickel-based) alloys.

Embodiment 23. The seal or seal assembly according to any one of the preceding embodiments, wherein the metal annular body comprises a low friction coating.

Embodiment 24. The seal or seal assembly according to embodiment 23, wherein the low friction coating comprises a polymer.

Embodiment 25. The seal or seal assembly according to embodiment 24, wherein the low friction coating comprises a fluoropolymer.

Embodiment 26. The seal or seal assembly according to any one of the preceding embodiments, wherein the seal has a length, L_{S}, of between 6 and 50 mm.

Embodiment 27. The seal or seal assembly according to any one of the preceding embodiments, wherein the seal has a width, W_{S}, of between 4 and 30 mm.

Embodiment 28. The seal or seal assembly according to any one of the preceding embodiments, wherein the elongated heel flange has a length, L_{H}, of between 2 and 20 mm.

Embodiment 29. The seal or seal assembly according to any one of the preceding embodiments, wherein the elongated heel flange has a width, W_{H}, of between 2 and 10 mm.

Embodiment 30. The seal or seal assembly according to any one of the preceding embodiments, wherein the first lip has a length, L_{FL}, of between 1 and 20 mm.

Embodiment 31. The seal or seal assembly according to any one of the preceding embodiments, wherein the first lip has a width, W_{FL}, of between 2 and 15 mm.

Embodiment 32. The seal or seal assembly according to any one of the preceding embodiments, wherein the second lip has a length, L_{SL}, of between 1 and 20 mm.

Embodiment 33. The seal or seal assembly according to any one of the preceding embodiments, wherein the second lip has a width, W_{SL}, of between 2 and 15 mm.

Embodiment 34. The seal or seal assembly according to any one of the preceding embodiments, wherein the seal assembly operates at a temperature of between −60° C. and 345° C.

Embodiment 35. The seal or seal assembly according to any one of the preceding embodiments, wherein the seal assembly operates at a pressure of between 69 and 207 MPa.

Embodiment 36. The seal or seal assembly according to any one of the preceding embodiments, wherein the assembly further includes a washer disposed within a cavity of the axially elongated heel portion.

Embodiment 37. The seal or seal assembly according to embodiment 36, wherein the elongated heel portion comprises at least on corrugation contacting the washer to provide an interference fit therebetween.

Embodiment 38. The seal or seal assembly according to any one of the preceding embodiments, wherein the washer comprises a metal.

Embodiment 39. The seal or seal assembly according to any one of the preceding embodiments, wherein the washer comprises a polymer.

Note that not all of the features described above are required, that a portion of a specific feature may not be required, and that one or more features may be provided in addition to those described. Still further, the order in which features are described is not necessarily the order in which the features are installed.

Certain features are, for clarity, described herein in the context of separate embodiments, may also be provided in combination in a single embodiment. Conversely, various features that are, for brevity, described in the context of a single embodiment, may also be provided separately or in any subcombinations.

Benefits, other advantages, and solutions to problems have been described above with regard to specific embodiments, However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or any change may be made without departing from the scope of the disclosure. Accordingly, the disclosure is to be regarded as illustrative rather than restrictive.

What is claimed is:

1. A seal comprising:
a metal annular body oriented down a central axis, the metal annular body comprising an axially elongated heel flange, a first lip, and a second lip defining an annular recess that bisects the central axis, wherein a radial midpoint of the axially elongated heel flange is radially offset from the central axis, a radial midpoint of the first lip, and a radial midpoint of the second lip.

2. A seal comprising:
a metal annular body oriented down a central axis, the metal annular body comprising an axially elongated heel flange defining a cavity, a first lip, and a second lip defining an annular recess that bisects the central axis; and
a washer disposed within the cavity of the axially elongated heel flange, wherein a radial midpoint of the washer is radially offset from the central axis, a radial midpoint of the first lip, and a radial midpoint of the second lip.

3. A seal assembly comprising:
a first member;
a second member; and
a seal disposed between the first member and the second member, the seal comprising:
a metal annular body oriented down a central axis, the metal annular body comprising an axially elongated heel flange, a first lip, and a second lip defining an annular recess that bisects the central axis, wherein a radial midpoint of the axially elongated heel flange is radially offset from the central axis, a radial midpoint of the first lip, and a radial midpoint of the second lip.

4. The seal according to claim 1, wherein the radial midpoint of the axially oriented heel flange is disposed closer to a radial midpoint of the first lip.

5. The seal according to claim 1, wherein the radial midpoint of the axially oriented heel flange is disposed closer to a radial midpoint of the second lip.

6. The seal according to claim 1, wherein the seal comprises an energizer housed within the annular recess.

7. The seal according to claim 1, wherein the energizer provides a radial biasing force against the first lip and the second lip of between 20 and 1500 N/mm.

8. The seal according to claim 1, wherein the annular recess has a U-shaped, C-shaped, or V-shaped cross-section.

9. The seal assembly according to claim 3, wherein at least one of the first or second lip is static within the seal assembly.

10. The seal assembly according to claim 3, wherein at least one of the first or second lip is dynamic within the seal assembly.

11. The seal according to claim 1, wherein the axially elongated heel flange has a rectilinear cross-section.

12. The seal according to claim 1, wherein the axially elongated heel flange has a rectangular cross-section.

13. The seal according to claim 1, wherein the axially elongated heel flange has a square cross-section.

14. The seal assembly according to claim 3, wherein the first lip is located radially exterior to the second lip.

15. The seal assembly according to claim 6, wherein the energizer is a coil spring.

16. The seal according to claim 1, wherein the metal annular body comprises a low friction coating comprising a polymer.

17. The seal assembly according to claim 3, wherein the assembly further includes a washer disposed within a cavity of the axially elongated heel portion.

18. The seal assembly according to claim 17, wherein the elongated heel portion comprises at least on corrugation contacting the washer to provide an interference fit therebetween.

19. The seal assembly according to claim 17, wherein the washer comprises a metal or a polymer.

20. The seal assembly according to claim 3, wherein the assembly comprises an additional seal.
